(19) United States
(12) Patent Application Publication
(10) Pub. No.: US 2018/0343233 A1
(43) Pub. Date: Nov. 29, 2018

(54) CONTEXTUAL NAME ASSOCIATION

(71) Applicant: Lenovo (Singapore) Pte. Ltd., Singapore (SG)

(72) Inventors: Ryan Charles Knudson, Durham, NC (US); Rod D. Waltermann, Rougemont, NC (US)

(21) Appl. No.: 15/603,780

(22) Filed: May 24, 2017

(51) Int. Cl. H04L 29/12; G06F 17/30; H04L 29/08

(52) U.S. Cl. CPC H04L 61/301; H04L 67/22; H04L 61/1594; G06F 17/30528

(57) ABSTRACT

One embodiment provides a method, including: receiving, at an information handling device, user input from at least one user, wherein the user input comprises a name not identified as a contact name of a stored contact; accessing, using a processor, contextual history data associated with the at least one user; determining, using the contextual history data, whether the name is associated with a contact name of a stored contact; and performing, responsive to determining the name is associated with the contact name, a function associated with the stored contact. Other aspects are described and claimed.

### BACKGROUND

Information handling devices (“devices”), for example smart phones, tablet devices, laptop computers, personal computers, and the like, may be capable of receiving and processing user command inputs. For example, a device can receive a user command directing the device to call Fred Jones, where Fred Jones is a contact name of a stored contact in the user's device or other storage location accessible to the device. Responsive to processing the command and identifying a corresponding stored contact, the device may contact the identified individual.

### BRIEF SUMMARY

In summary, one aspect provides a method, comprising: receiving, at an information handling device, user input from at least one user, wherein the user input comprises a name not identified as a contact name of a stored contact; accessing, using a processor, contextual history data associated with the at least one user; determining, using the contextual history data, whether the name is associated with a contact name of a stored contact; and performing, responsive to determining the name is associated with the contact name, a function associated with the stored contact.

Another aspect provides an information handling device, comprising: a processor; a memory device that stores instructions executable by the processor to: receive user input from at least one user, wherein the user input comprises a name not identified as a contact name of a stored contact; access contextual history data associated with the at least one user; determine, using the contextual history data, whether the name is associated with a contact name of a stored contact; and perform, responsive to determining the name is associated with the contact name, a function associated with the stored contact.

A further aspect provides a product, comprising: a storage device that stores code, the code being executable by a processor and comprising: code that receives user input from at least one user, wherein the user input comprises a name not identified as a contact name of a stored contact; code that accesses contextual history data associated with the at least one user; code that determines, using the contextual history data, whether the name is associated with a contact name of a stored contact; and code that performs, responsive to determining the name is associated with the contact name, a function associated with the stored contact.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of determining whether a name in user-provided input is associated with a contact name of a stored contact.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Users frequently utilize devices to execute a variety of different commands. One method of interacting with a device is to use digital assistant software employed on the device (e.g., Siri® for Apple®, Cortana® for Windows®, Alexa® for Amazon®, etc.). A common command received by digital assistants is a communication command, where a user instructs a digital assistant to begin a communication (e.g., call, text, email, etc.) with a stored contact in a user's contact list. For example, a user may instruct (e.g., using vocal input provided to a microphone, etc.) a digital assistant to call a stored contact named Charles Smith. Responsive to receiving the input and identifying that the name in the user input is associated with the stored contact Charles Smith, the digital assistant may then access Charles Smith's stored contact information and dial the phone number contained therein.

Conventionally, in order for a digital assistant to initiate a communication with the desired contact, the user must communicate the contact's name exactly how it is provided in the contact list. For example, if a user wishes to contact a friend named Charles Smith, the user must provide the command “Call Charles Smith” or “Email Charles Smith”. However, these conventional methods are unable to identify and associate nicknames, or other alternative names, that a user may frequently use to refer to their stored contacts. For example, if a user frequently refers to the stored contact Charles Smith as “Chuck”, conventional methods will be unable to identify that a user wishes to call Charles Smith when they provide the communication command “Call Chuck”.

Existing solutions are ephemeral (i.e., limited to one-time use) and require an extra step from both the device and the user. For example, a user may provide the audible command input, “Call Mom”, to a device or a digital assistant employed by the device. If the digital assistant is unable to associate the target name with a stored contact, for example, because the contact name is not listed as Mom, the digital assistant may provide clarification output to the user such as “Who is Mom?” A user may then inform the digital assistant that Mom refers to Marsha Smith, after which the digital assistant may access and dial the phone number associated with Marsha Smith. However, the next time a user provides the command input “Call Mom,” the entire process needs to be repeated. Such a process is time-consuming and may become frustrating.

Accordingly, an embodiment provides a method for determining whether a name included in user input is associated with a contact name of a stored contact. In an embodiment, user input comprising a name may be received from at least one user. The name may be a nickname the user uses to refer to a contact in a stored contact list. However, the name included in the user input is not itself identified as a contact name of a stored contact. Subsequent to receiving the user input, an embodiment may access contextual history data associated with the user to determine whether the name is associated with a stored contact name. An embodiment may then perform a function associated with the stored contact name. Such a method may eliminate the need for a user to provide clarification input as to who the name in the user-provided input refers to.

The illustrated example embodiments will be best understood by reference to the figures. The following description is intended only by way of example, and simply illustrates certain example embodiments.

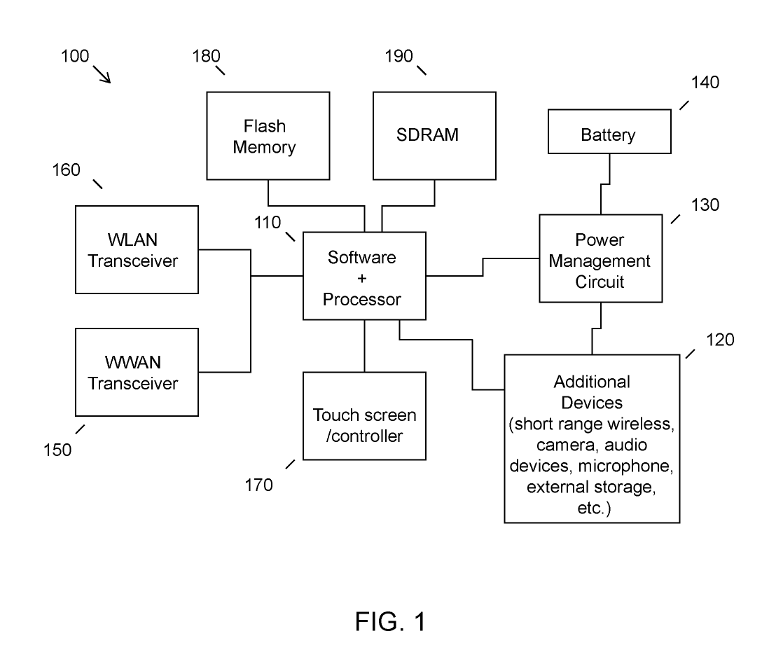

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera. System 100 often includes a touch screen 170 for data input and display/rendering. System 100 also typically includes various memory devices, for example flash memory 180 and SDRAM 190.

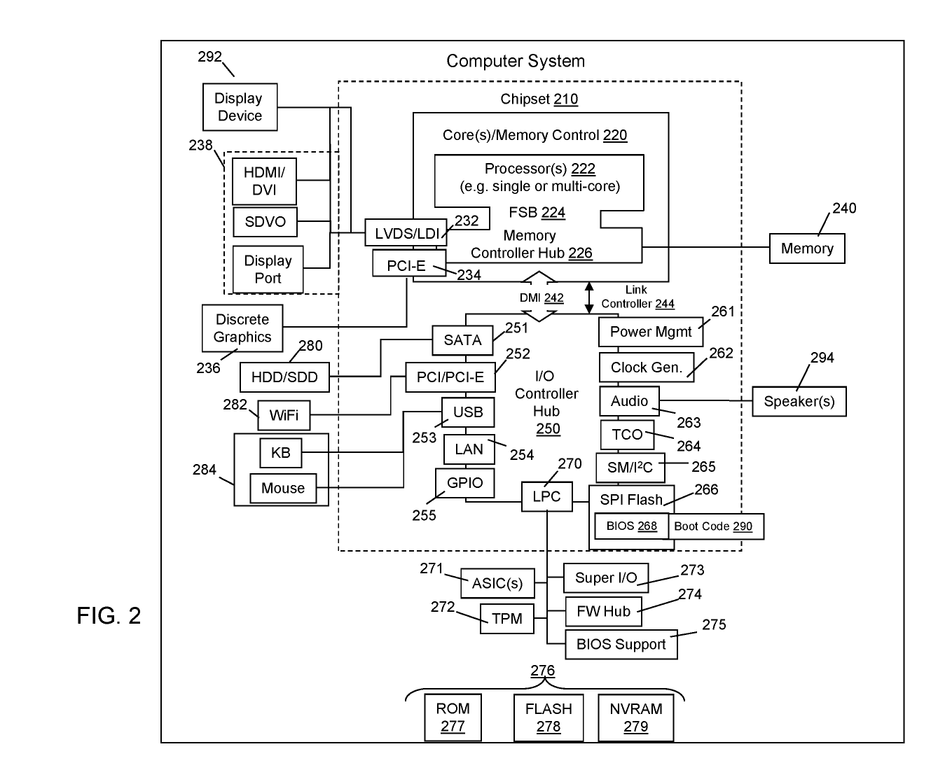

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices which may include digital assistants that a user may interact with and that may perform various functions responsive to receiving user input. For example, the circuitry outlined in FIG. 1 may be implemented in a tablet or smart phone embodiment, whereas the circuitry outlined in FIG. 2 may be implemented in a personal computer embodiment.

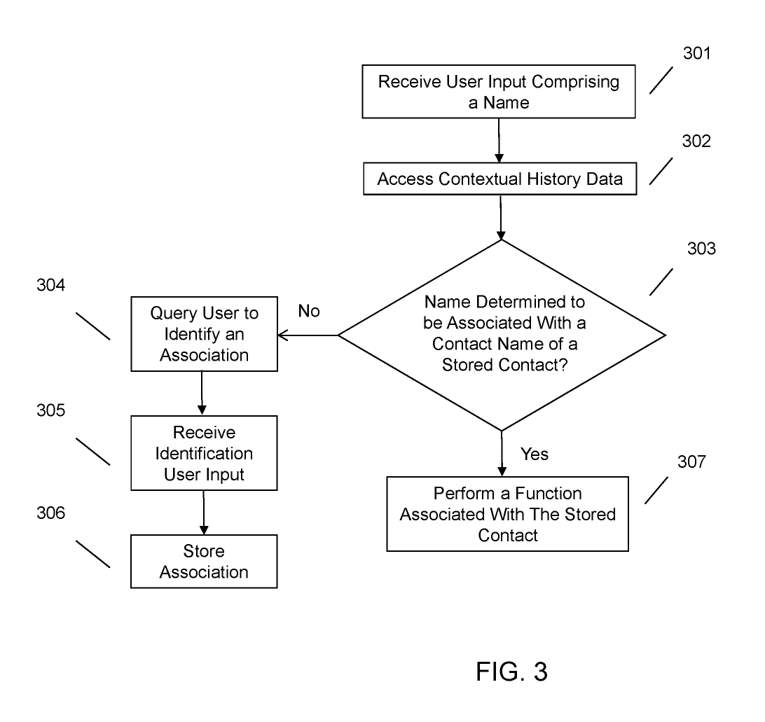

Referring now to FIG. 3, an embodiment may perform a function responsive to determining that a name included in user input is associated with a stored contact. At 301, an embodiment may receive input from at least one user. The input may be received at an input device (e.g., physical keyboard, on-screen keyboard, audio capture device, image capture device, video capture device, a digital assistant, etc.) and may be provided by any known method of providing input to an electronic device (e.g., touch input, text input, voice input, etc.). For simplicity purposes, the majority of the discussion herein will involve an audio input device and voice input. However, it should be understood that generally any form of user input may be utilized. In an embodiment, the user input may be any type of input such as a command input, query input, and the like.

In an embodiment, the user input may comprise a name and possibly an action to be performed by the assistant with respect to the name, for example, an action to communicate with the contact via calling, texting, emailing, video chatting, and the like. In an embodiment, the name may be a nickname that is used to refer to or distinguish an individual. However, that name may not be identified as a contact name of a stored contact. For example, the nickname may be Mom, while the actual contact name associated with the stored contact is Marsha Smith. In an embodiment, the nickname may not bare any phonetic or visual similarity with the stored contact name. For example, a user may have a stored contact (e.g., in their contact list, etc.) named Jesus Martinez. A user may provide the audible command input “call Chuy,” where Chuy is a nickname the user associates with Jesus Martinez. In another embodiment, the name may be a portion of a stored contact's name. For example, a user may have a stored contact named Phillip Morris. A user may provide the audible command input “email Phil,” where Phil is an abbreviation of the stored contact's first name. In an embodiment, the stored contacts may be located in a database accessible by the device (e.g., stored locally on the device, stored in the cloud, stored in a network location, a combination thereof, etc.)

At 302, an embodiment may access contextual history data associated with the user. In an embodiment, the contextual history data may be accessed from at least one source (e.g., text messages, emails, social media posts, calendar entries, call history, etc.) associated with the user. In an embodiment, the contextual history data may be stored in a data storage location accessible by the system, for example, locally (e.g., on the device, etc.), remotely (e.g., the cloud, network storage location, etc.), or a combination thereof. Contextual history data may include any data that indicates an association between a stored contact name and another name that the user associates with that stored contact. For example, a user's calendar may identify that Marsha Smith is a person referred to by the user as Mom. As another example, an email program may indicate that the user has provided a nickname, Mad, for a person name Adam Maddox.

An embodiment may utilize the contextual history data to determine, at 303, if the name provided in the user input is associated with a contact name of a stored contact. For example, a user may send the following text message to the stored contact Charles Smith, “Sounds good, talk to you later Chuck”. Based on the context of the text message, an embodiment may determine, at 303, that Chuck is associated with the stored contact Charles Smith. Alternatively, in another example, a user may write an email to a stored contact named Charles Smith with the salutation “Dear Chuck”. Based on the name identified in the salutation, an embodiment may determine, at 303, that Chuck is associated with Charles Smith. It is worth noting that these are non-limiting examples and additional contexts may be used to determine an association between a name in user-provided input and a stored contact.

By utilizing these determined associations, an embodiment may match nicknames to stored contacts. An embodiment also may be able to differentiate between multiple similarly named stored contacts. For example, a user may have three stored contacts named Phillip Smith, Phillip Katko, and Phillip Morrow. An embodiment may be able to determine, by accessing contextual history data, that a user refers to Phillip Smith as “Smithy”, Phillip Katko as “Katko”, and Phillip Morrow as “Phil”. Therefore, when a user provides the command input “call Phil”, an embodiment may be able to determine that the user intends to call the stored contact Phillip Morrow and not either of the other two Phillips.

In an embodiment, multiple users may access and use a single device. In such a situation, an embodiment may identify a user prior to accessing contextual data associated with that particular user. For example, multiple users may have the ability to access a device by logging into a user profile. Each user profile may contain a variety of settings, including contextual data, which may be specific to the identified user. For example, User A may gain access to a user profile on a device by providing user identification data (e.g., a digital fingerprint, user-associated passcode, user credentials, biometric data, device data, etc.) to an input field on a login screen of the device. Subsequent to granting User A access to their user profile, an embodiment may have access to contextual data associated with User A. If User B logs in to a user profile associated with User B on the same device, an embodiment may access contextual data specific to User B rather than the contextual data associated with User A.

Responsive to determining, at 303, that a name included in user input is associated with a contact name of a stored contact, an embodiment may perform, at 307, a function associated with the stored contact. The function may include the requested action that was included in the user input. For example, responsive to determining that the name Chuck is associated with Charles Smith, an embodiment may populate an input field with information (e.g., name, address, phone number, etc.) associated with Charles Smith. In another example, responsive to receiving the user command input “Call Chuck,” an embodiment may access contact information associated with Charles Smith and then call Charles Smith. Other contact commands may be also be used such as “text Chuck”, “email Chuck”, and the like.

Responsive to determining, at 303, that a name is not associated with a contact name of a stored contact, an embodiment may query, at 304, the user to identify an association. The query output may be audio output, textual output, a combination thereof, or the like. In an embodiment, the audible output may be provided though a speaker, another output device, and the like. In an embodiment, the output device may be integral to the device or may be located on another device. In the case of the latter, the output device may be connected via a wireless or wired connection to the device.

In an embodiment, an example query output may be an audible output such as “I do not recognize any contact associated with that name. Can you please identify an association?” or “Who's Chuck?” Responsive to receiving the query output, an embodiment may receive, at 305, additional user input to identify a contact name associated with the nickname. The additional user input may be, for example, a vocal identification of the stored contact name, a selection of a stored contact from a user's contact list, and the like. An embodiment may then associate the identified contact name with the nickname and may store, at 306, the association in the contextual history. An embodiment may also store the identification in another database. Thereafter, upon subsequent uses of the nickname, an embodiment may be able to recognize the stored contact name the nickname is associated with. Additional to making the association, the system may perform the requested action included in the user input.

The various embodiments described herein thus represent a technical improvement to conventional name association techniques. Using the techniques described herein, an embodiment may determine whether a name included in user input is associated with a contact name of a stored contact. An embodiment may then perform a function associated with the stored contact. Such techniques eliminate the requirement for users to provide the exact contact named of a stored contact and instead may allow users to refer to stored contacts by alternative names, such as nicknames.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at an information handling device, user input from at least one user, wherein the user input comprises a name not identified as a contact name of a stored contact;
accessing, using a processor, contextual history data associated with the at least one user;
determining, using the contextual history data, whether the name is associated with a contact name of a stored contact; and
performing, responsive to determining the name is associated with the contact name, a function associated with the stored contact.

2. The method of claim 1, wherein the name comprises a nickname.

3. The method of claim 1, wherein the performing comprises populating at least one input field with information associated with the stored contact.

4. The method of claim 1, wherein the performing comprises contacting the stored contact.

5. The method of claim 1, wherein the accessing comprises accessing the contextual history data from at least one source selected from the group consisting of text messages, emails, social media, and call history.

6. The method of claim 1, further comprising, responsive to determining that the name is not associated with the contact name, querying the at least one user to identify the contact name associated with the name.

7. The method of claim 6, further comprising storing the identification in a database.

8. The method of claim 6, further comprising associating the name with the contact name and storing the association in the contextual history.

9. The method of claim 1, further comprising identifying the at least one user.

10. The method of claim 9, further comprising accessing, based on the identifying, contextual history data associated with the identified at least one user.

11. An information handling device, comprising:
a processor;
a memory device that stores instructions executable by the processor to:
receive user input from at least one user, wherein the user input comprises a name not identified as a contact name of a stored contact;
access contextual history data associated with the at least one user;
determine, using the contextual history data, whether the name is associated with a contact name of a stored contact; and
perform, responsive to determining the name is associated with the contact name, a function associated with the stored contact.

12. The information handling device of claim 11, wherein the name comprises a nickname.

13. The information handling device of 11, wherein the instructions executable by the processor to perform comprises instructions executable by the processor to populate at least one input field with information associated with the stored contact.

14. The information handling device of claim 11, wherein the instructions executable by the processor to perform comprise instructions executable by the processor to contact the stored contact.

15. The information handling device of claim 11, wherein the instructions executable by the processor to access comprise instructions executable by the processor to access the contextual history data from at least one source selected from the group consisting of text messages, emails, social media, and call history.

16. The information handling device of claim 11, wherein the instructions are further executable by processor to query, responsive to determining that the name is not associated with the contact name, the at least one user to identify the contact name associated with the name.

17. The information handling device of claim 16, wherein the instructions are further executable by the processor to store the identification in a database.

18. The information handling device of claim 16, wherein the instructions are further executable by the processor to associate the name with the contact name and store the association in the contextual history.

19. The information handling device of claim 1, wherein the instructions are further executable by the processor to identify the at least one user and access, based on the identification, contextual history data associated with the identified at least one user.

20. A product, comprising:
a storage device that stores code, the code being executable by a processor and comprising:
code that receives user input from at least one user, wherein the user input comprises a name not identified as a contact name of a stored contact;
code that accesses contextual history data associated with the at least one user;
code that determines, using the contextual history data, whether the name is associated with a contact name of a stored contact; and
code that performs, responsive to determining the name is associated with the contact name, a function associated with the stored contact.
